(19) United States
(12) Patent Application Publication
(10) Pub. No.: US 2009/0221393 A1
(43) Pub. Date: Sep. 3, 2009

(54) Differential Gearing Unit For Motor Vehicles With Active Control Of The Drive Force Distribution

(75) Inventor: Helmut Kassler, Voitsberg (AT)

Correspondence Address: BACHMAN & LAPOINTE, P.C., 900 CHAPEL STREET, SUITE 1201, NEW HAVEN, CT, 06510, US

(73) Assignee: MAGNA STEYR FAHRZEUGTECHNIK AG & CO KG, Graz (AT)

(21) Appl. No.: 12/088,089

(22) PCT Filed: Sep. 29, 2006
(86) PCT No.: PCT/AT2006/000399

§ 371 Date: Oct. 29, 2008

(30) Foreign Application Priority Data
Sep. 29, 2005 (AT) GM 660/2005

(51) Int. Cl. F16H 37/08

(52) U.S. Cl. 475/205

(57) ABSTRACT

A differential gearing unit for motor vehicles is composed of a housing and, therein, a differential gearing, a step-up and step-down gearing and two controllable friction clutches, with the differential gearing being composed of a driven element and a first and a second drive output element, and transmitting an additional torque to the first and second drive output element as a function of the degree of engagement of the friction clutches. In order to be able to absorb very high forces with the smallest installation space and lowest amount of wear, the step-up and step-down gearing has a first element, which is rotationally fixedly connected to the driven element (8) of the differential gearing, and a second element which is rotationally fixedly connected by means of in each case one friction clutch to the respective drive output element of the differential gearing, and a third element of the step-up and step-down gearing is embodied as a toothed ring which is guided in eccentric bearings and which has an external toothing (24) and an internal toothing.

The invention relates to a differential gearing unit for motor vehicles is composed of a housing and, therein, a differential gearing, a step-up and step-down gearing and two controllable friction clutches, with the differential gearing being composed of a driven element (for example a differential cage) and a first and a second drive output element, for example the axle shafts, with the step-up and step-down gearing transmitting an additional torque to the first and second drive output element as a function of the degree of engagement of the friction clutches.

Units of said type permit the active control of the drive force distribution between the two drive output elements. Said drive output elements are drive-connected either to a first and second driven axle of a motor vehicle or, preferably, to the two wheels of an axle. The step-up and step-down gearing generates a step-up or step-down transmission ratio such that, by means of the friction clutches which can be controlled oppositely to one another, an additional drive or braking torque can be imparted to the respective drive output element depending on the driving situation. Among experts, this is referred to as “torque vectoring”.

U.S. Pat. No. 5,370,588 discloses a differential gearing unit in which in each case one step-up and step-down gearing, of ring-gear-free design with double planets, is formed at each side and is rotationally fixedly connected in each case to one side of a clutch. In said design, the friction clutches are difficult to access and their actuating arrangement is difficult to accommodate. The step-up and step-down gearing is a fixed-axle gearing whose output and input elements are coaxial; said fixed-axle gearing can also be referred to as a coaxial gearing.

U.S. Pat. No. 4,973,296 discloses a generic differential gearing unit in which the step-up and step-down gearing is a parallel-axle gearwheel stage whose second axle does not coincide with the rotational axis of the drive output elements. Said design as an axle differential requires a large amount of installation space in the vehicle longitudinal direction, not least because the step-up and step-down gearing is close to 1:1 and both gearwheels are therefore approximately the same size.

It is therefore an object of the invention to further develop a generic differential gearing in such a way that it can absorb very high forces with the smallest installation space and lowest amount of wear. According to the invention, this is achieved in that the step-up and step-down gearing has a first element, which is rotationally fixedly connected to the driven element of the differential gearing, and a second element which is rotationally fixedly connected by means of in each case one friction clutch to the respective drive output element of the differential gearing, and in that a third element of the step-up and step-down gearing is embodied as a toothed ring which is guided in eccentric bearings and which has an external toothing and an internal toothing. The toothed ring is mounted eccentrically in the housing with respect to the axis of the drive output elements.

A simple coaxial gearing of small construction is thus provided as a step-up and step-down gearing at both sides in the direct vicinity of the clutch, which results overall in favourable force profiles and saves installation space. The toothed ring concentrically surrounds the sun gear, in the manner of an oil feed ring in a plain bearing of historic design, wherein said toothed ring can also actually impart said action. Although said particular gearing type is known per se, see for example the U.S. Pat. No. 1,619,127 or 773,227, it is not known in connection with friction clutches for controlling the torque distribution and with the object on which the invention is based.

Said gearing type makes it possible to realize the transmission ratios which are favorable for this purpose in a very small space, for geometric reasons and because internal toothings have very high overlap rates (there are a large number of teeth in engagement simultaneously, between which the forces which are to be transmitted are distributed). The high overlap rate also permits a particularly narrow and therefore space-saving design of the toothed elements. The possible transmission ratios permit an optimum design of the friction clutch for the corresponding rotational speed differences, which contributes to the protection of said friction clutch and, in combination with good lubrication/cooling, makes said friction clutch particularly suitable for permanent slip operation.

The step-up and step-down gearing is a coaxial gearing, whose first element is either a ring gear which meshes with the external toothing of the third element (Claim 2) or a sun gear which meshes with the internal toothing of the third element (Claim 3). In both cases, high overlap rates of the tooth engagement and step-up and step-down gearing ratios close to 1:1 can be easily obtained.

In one preferred embodiment, the primary part, which supports the outer plates, of the friction clutches is drive-connected to the second element of the step-up and step-down gearing and the secondary part, which supports the inner plates, is drive-connected to the respective drive output element (Claim 4). Here, the second element can be the sun gear or also the ring gear.

If the entire differential gearing unit can or must be asymmetrical in the transverse direction, it is possible to achieve greater space economy if the two friction clutches are arranged on the same side of the differential gearing (Claim 4); their primary parts are then preferably structurally combined to form a bell (Claim 5).

In one refinement of the invention, a clutch for selectively connecting a drive output element of the differential gearing to the driven element thereof is arranged on that side of the differential gearing which faces away from the step-up and step-down gearing (Claim 6). It is thus possible to create a differential lock which is preferably also a controllable friction clutch (Claim 7).

For all-wheel drive motor vehicles in the drivetrain of which the drive torque for a second driven axle is branched off from the axle differential of the first driven axle, the driven element of the axle differential is drive-connected to a drive output wheel for a further driven axle (Claim 8). With the said disposition of the drivetrain, it is particularly advantageous to arrange the drive output wheel between the differential and the step-up and step-down gearing. The propeller shaft which leads to the second driven axle thus comes to rest approximately in the longitudinal center of the motor vehicle.

In a simplification of said refinement, it is also possible for the torque apportioned to the second driven axle to be controlled by means of a further (third) friction clutch (Claim 9). One clutch half of the further clutch is preferably then structurally combined with the first element of the step-up and step-down gearing (Claim 10).

The differential gearing unit according to the invention is described and explained below on the basis of schematic figures of various embodiments. In the figures:

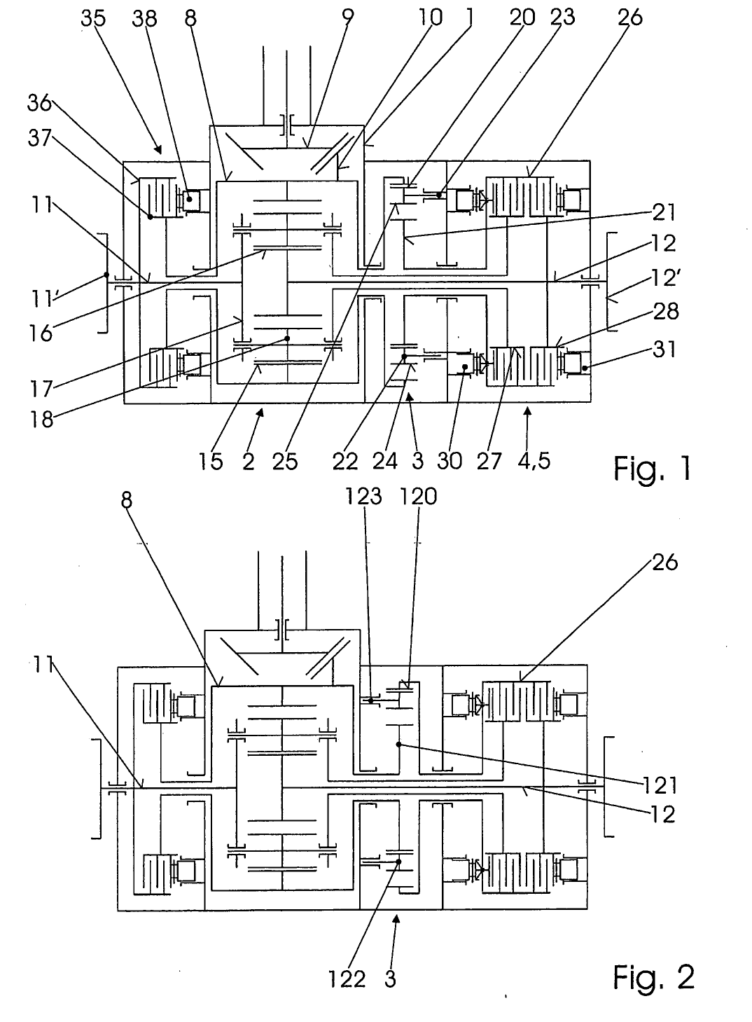

FIG. 1 shows a first embodiment,

FIG. 2 shows a second embodiment,

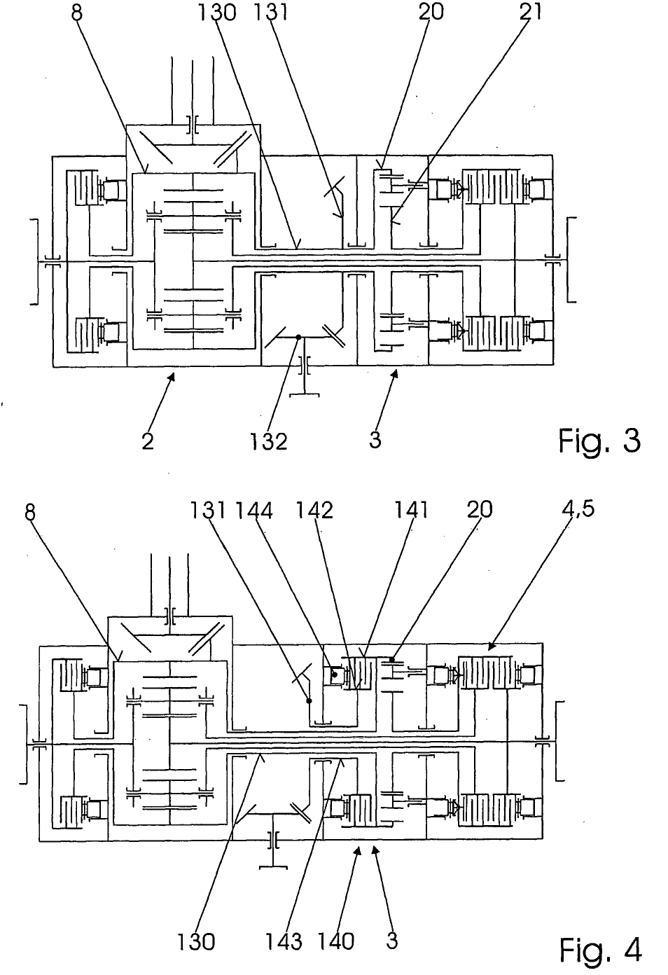

FIG. 3 shows a third embodiment,

FIG. 4 shows a fourth embodiment.

In FIG. 1, the housing is merely indicated and is denoted by 1. Said housing contains a differential gearing 2, a step-up and step-down gearing 3 and two controllable friction clutches 4, 5. The drive torque which is provided by an engine transmission unit (not illustrated) is supplied to a differential cage 8, the driven element of the differential gearing 2, via a pinion 9 and a crown gear 10. In the case of a transverse arrangement of the engine transmission block, a spur gearwheel is provided instead of the crown gear 10. The differential gearing distributes the drive force between two coaxial drive output elements 11, 12 which are connected by means of flanges 11′, 12′ either to propeller shafts which lead to the axles of a motor vehicle or to axle shafts which lead to the wheels of an axle (all not illustrated).

The differential gearing 2 can, within the context of the invention, be of any desired design, that is to say either a bevel gear differential or a planetary gear differential. If the differential gearing 2 is of the latter type, it is composed of a ring gear 15 which is fixedly connected to the differential cage 8, a sun gear 16 which is fixedly connected to the second drive output element 12, and a planet carrier which is rotationally fixedly connected to the first drive output element 11 and which is provided with planet gears 18. In order to obtain a symmetrical torque distribution, the planet gears are arranged in a known way such that they mesh with one another in pairs and in each case one with the ring gear 15 and one with the sun gear 16.

The step-up and step-down gearing 3 is a coaxial gearing, in particular a planetary gear set of a particular design. Said step-up and step-down gearing 3 is composed of a ring gear 20 (first element in FIG. 1), a sun gear 21 (second element in FIG. 1) and a toothed ring 22 (third element in FIGS. 1 and 2). The toothed ring 22 is guided in bearings 23, which are fixed to the housing and which are eccentric with respect to the drive output elements 11,12, and is a ring which surrounds the sun gear 21 and which has an external toothing 24 and an internal toothing 25. The external toothing 24 meshes with the ring gear 20, and the internal toothing 25 meshes with the sun gear 21. The ring gear 20 is rotationally fixedly connected to the differential cage 8, and the sun gear 21 is rotationally fixedly connected to the friction clutches 4, 5. It is notable that only one step-up and step-down gearing 3 is provided.

The controllable friction clutches 4, 5 adjoin that side of the step-up and step-down gearing 3 which faces away from the differential gearing 2. The two friction clutches 4, 5 have a common primary part 26 which forms a bell and which is rotationally fixedly connected to the sun gear 21 in FIG. 1. Of the two secondary parts 27, 28, the separate secondary parts of the two friction clutches 4, 5, the first is drive-connected through the planet carrier 17 of the differential gearing 2 to the first drive output element 11 of the latter. The secondary part 28 of the second clutch 5 is directly connected to the second drive output element 12 of the differential gearing 2; directly because the second drive output element is on the same side as the friction clutches 4, 5. Separate actuators 30, 31 are provided for the two friction clutches 4, 5. Said friction clutches 4, 5 permit an independent, also opposing, activation of the two friction clutches 4, 5 from one another.

Provided on the other side of the differential gearing 2 is a third friction clutch 35 as a controllable differential lock. Said third friction clutch 35 is composed of an outer part 36 which is rotationally fixedly connected to the first drive output element 11 and an inner part 37 which is rotationally fixedly connected to the differential cage 8. An actuator 38 is provided for activation.

FIG. 2 differs from FIG. 1 merely in that the step-up and step-down gearing 3 is connected in differently. Here, the first element which is connected to the differential cage 8 is the sun gear 121 and the secondary part which is rotationally fixedly connected to the common primary part 26 of the clutches 4, 5 is the ring gear 120. Everything else is the same, for which reason the remaining parts are also provided with the reference symbols of FIG. 1.

In FIG. 3, the embodiment of FIG. 1 has added to it a drive output for a further driven axle (not illustrated). Inserted as a connection between the differential cage 8 and the ring gear 20 is a hollow shaft 130 on which is seated a drive output wheel 131 which, here, outputs drive force for the further axle via an angular gear 132. As a result of the hollow shaft 130, the drive output wheel 131 is arranged between the differential gearing 2 and the step-up and step-down gearing 3.

In FIG. 4, the embodiment of FIG. 3 has inserted into it a further friction clutch 140. Said further friction clutch 140 has the purpose of also adjusting the torque which can be supplied to the further driven axle. For this purpose, the hollow shaft 30 is guided from the differential cage 8 to the clutch outer part 141 which is fixedly connected to or, as is the case here, formed in one piece with the ring gear 20 of the step-up and step-down gearing 3. The inner part 142 of the clutch 140 is connected by means of a hollow shaft 143 which surrounds the hollow shaft 130 to the drive output wheel 131. The actuator for said further friction clutch 140 is denoted by 144.

With regard to the structural design of the individual components of the described embodiments (in particular of the toothed ring 22), reference is made to the slightly earlier Austrian utility model application no. GM 112/2005.

The transmission ratio of the step-up and step-down gearing and the configuration thereof can be adapted within a wide range to the occurring driving dynamic demands of a motor vehicle. A step-up or step-down transmission ratio of the required order of magnitude has been made structurally possible with the minimum spatial requirement as a result of its particular configuration with optimum design of the toothing. It should finally be noted that the differential gearing unit according to the invention can transmit torques between the two axle shafts even without drive by means of corresponding activation of the friction clutches.

1. Differential gearing unit for motor vehicles, comprising a housing and, therein, a differential gearing, a step-up and step-down gearing and two controllable friction clutches, with the differential gearing comprising a driven element and a first and a second drive output element, and with the step-up and step-down gearing transmitting an additional torque to the first and second drive output element as a function of the degree of engagement of the friction clutches wherein
a) the step-up and step-down gearing has a first element, which is rotationally fixedly connected to the driven element of the differential gearing, and a second element which is rotationally fixedly connected by means of in each case one friction clutch to the respective drive output element of the differential gearing, and
b) in that a third element of the step-up and step-down gearing is embodied as a toothed ring which is guided in eccentric bearings and which has an external toothing and an internal toothing.

2. Differential gearing unit according to claim 1, wherein the step-up and step-down gearing is a coaxial gearing, with the first element being a ring gear which meshes with the external toothing of the third element and the second element being a sun gear which meshes with the internal toothing of the third element.

3. Differential gearing unit according to claim 1, wherein the step-up and step-down gearing is a coaxial gearing, with the first element being a sun gear which meshes with the internal toothing of the third element and the second element is a ring gear which meshes with the external toothing of the third element.

4. Differential gearing unit according to claim 1, with the friction clutches comprising in each case a primary part and a secondary part, wherein the primary part is drive-connected to the second element of the step-up and step-down gearing and the secondary part is drive-connected to the respective drive output element.

5. Differential gearing unit according to claim 4, wherein the two friction clutches are arranged on the same side of the differential gearing and their primary parts are combined to form a bell.

6. Differential gearing unit according to claim 5, wherein a clutch for selectively connecting a drive output element of the differential gearing to the driven element thereof is arranged on that side of the differential gearing which faces away from the step-up and step-down gearing.

7. Differential gearing unit according to claim 6, wherein the clutch is a further controllable friction clutch.

8. Differential gearing unit according to claim 1, wherein the differential gearing is an axle differential and wherein the driven element thereof is drive-connected to a drive output wheel for a further driven axle.

9. Differential gearing unit according to claim 8, wherein a further friction clutch is arranged between the driven element and the drive output wheel for a further driven axle.

10. Differential gearing unit according to claim 9, wherein one clutch half of the further clutch is structurally combined with the first element, of the step-up and step-down gearing.
